(19) United States
(12) Patent Application Publication
(10) Pub. No.: US 2008/0025199 A1
(43) Pub. Date: Jan. 31, 2008

(54) METHOD AND DEVICE FOR HIGH THROUGHPUT N-POINT FORWARD AND INVERSE FAST FOURIER TRANSFORM

(75) Inventors: LIN YANG, Fremont, CA (US); HAIYUN YANG, San Jose, CA (US)

Correspondence Address: FRANKLIN (LIN) YANG, 91 CANTERBURY GATE, LYNBROOK, NY, 11563, US

(73) Assignee: LEGEND SILICON, Fremont, CA (US)

(21) Appl. No.: 11/550,390

(22) Filed: Oct. 17, 2006

Related U.S. Application Data
(60) Provisional application No. 60/820,319, filed on Jul. 25, 2006.

(51) Int. Cl. H04J 11/00; H04J 1/00

(52) U.S. Cl. 370/210; 370/480

(57) ABSTRACT

This invention relates to the architecture of a 3780-point forward and inverse Fast Fourier Transform (DFT), which is used in a TDS-OFDM system. The number 3780 is factored to 3*3* . . . *3*M. Where M is a natural number that cannot be factored by 3.

### REFERENCE TO RELATED APPLICATIONS

This application claims an invention which was disclosed in Provisional Application No. 60/820,319, filed Jul. 25, 2006 entitled “Receiver For An LDPC based TDS-OFDM Communication System”. The benefit under 35 USC §119(e) of the United States provisional application is hereby claimed, and the aforementioned application is hereby incorporated herein by reference.

### FIELD OF THE INVENTION

The present invention relates generally to communication devices. More specifically, the present invention relates to method and device for high throughput N-point forward and inverse Fast Fourier Transform with N=3*3* . . . *3*M.

### BACKGROUND

OFDM (Orthogonal frequency-division multiplexing) is known. U.S. Pat. No. 3,488,445 to Chang describes an apparatus and method for frequency multiplexing of a plurality of data signals simultaneously on a plurality of mutually orthogonal carrier waves such that overlapping, but band-limited, frequency spectra are produced without casing interchannel and intersymbol interference. Amplitude and phase characteristics of narrow-band filters are specified for each channel in terms of their symmetries alone. The same signal protection against channel noise is provided as though the signals in each channel were transmitted through an independent medium and intersymbol interference were eliminated by reducing the data rate. As the number of channels is increased, the overall data rate approaches the theoretical maximum.

OFDM transreceivers are known. U.S. Pat. No. 5,282,222 to Fattouche et al describes a method for allowing a number of wireless transceivers to exchange information (data, voice or video) with each other. A first frame of information is multiplexed over a number of wideband frequency bands at a first transceiver, and the information transmitted to a second transceiver. The information is received and processed at the second transceiver. The information is differentially encoded using phase shift keying. In addition, after a pre-selected time interval, the first transceiver may transmit again. During the preselected time interval, the second transceiver may exchange information with another transceiver in a time duplex fashion. The processing of the signal at the second transceiver may include estimating the phase differential of the transmitted signal and pre-distorting the transmitted signal. A transceiver includes an encoder for encoding information, a wideband frequency division multiplexer for multiplexing the information onto wideband frequency voice channels, and a local oscillator for upconverting the multiplexed information. The apparatus may include a processor for applying a Fourier transform to the multiplexed information to bring the information into the time domain for transmission.

Using PN (pseudo-noise) as the guard interval in an OFDM is known.

U.S. Pat. No. 7,072,289 to Yang et al describes a method of estimating timing of at least one of the beginning and the end of a transmitted signal segment in the presence of time delay in a signal transmission channel. Each of a sequence of signal frames is provided with a pseudo-noise (PN) m-sequences, where the PN sequences satisfy selected orthogonality and closures relations. A convolution signal is formed between a received signal and sequence of PN segments and is subtracted from the received signal to identify the beginning and/or end of a PN segment within the received signal. PN sequences are used for timing recovery, for carrier frequency recovery, for estimation of transmission channel characteristics, for synchronization of received signal frames, and as a replacement for guard intervals in an OFDM context.

Fourier transform is known. In electronic communications, the discrete Fourier transform (DFT) technique has been widely used. For a N sampled signal x(n) (n=0, 1, . . . , N−1), its DFT X(k) (k=0,1, . . . , N−1) is expressed as

$$X ( k ) = \frac{1}{N} {\sum }_{k = 0}^{N - 1} x ( n ) \cdot {e}^{- j \frac{2 π kn}{N}} \qquad ( 1 )$$

The direct computation of the above equation takes O(N²) arithmetical operation. It is too complicated when N becomes large. In 1965, Cooley and Tukey published an algorithm which only takes O(N log N) arithmetical operations to compute X(k)[1]. This algorithm and some other algorithms for computing DFT efficiently are referred as the Fast Fourier Transform (DFT). In general, such algorithms depend upon the factorization of N. For example, if a composition of number N can be expressed as a product of N1, N2, N3, N4, that is N=N₁·N₂·N₃·N₄. In this case, using the FFT algorithm, the N-point DFT can be broken into four stages. The first stage has multiple N₁-point DFT operation, the second stage has multiple N₂-point DFT operation, and etc. Since 2-point DFT is easiest one for implementation, most of application choose the integer N to be a value in power of 2 [2].

Unfortunately, in the TDS-OFDM context, due to co-existence of the time-domain and frequency-domain factors within one frame, a value of 3780 (not in power of 2 or a factor of 2) has to be chosen. Therefore, how to efficiently implement the thing becomes a key issue in the transmittor and receiver implementation in the TDS-OFDM system.

As can be seen, it is desirous to have new scheme for non-2 factoring in a FFT environment where a number cannot be factored into a series of 2s.

### SUMMARY OF THE INVENTION

A N-point DFT where N is a natural number capable of being factored into N=3*3* . . . *3*M, a DFT scheme and its associated structure are provided. M is a natural number capable of being factored into non-3 numbers.

In a receiver comprising N-point DFT where N is a natural number capable of being factored in N=3*3* . . . *3*M, a DFT scheme and it associated structure are provided. M is a natural number capable of being factored into non-3 numbers.

A scheme is provided in a 3780-point DFT, which can be decomposited as 3780=3*3*3*2*2*5*7. An associated architecture to implment this 3780-point forward and inverse FFT both of which are required in the TDS-OFDM transistors and receivers are provided.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a receiver in accordance with some embodiments of the invention.

FIG. 2 is an example of a first stage circuit construction in a first state of an embodiment of the invention.

FIG. 2A is an example of a first stage circuit construction in a second state of an embodiment of the invention.

FIG. 2B is an example of a first stage circuit construction in a last but one state of an embodiment of the invention.

FIG. 3 is the associated time-line to the first stage circuit construction of FIG. 2.

FIG. 4 is an example of a second stage circuit construction of an embodiment of the invention.

FIG. 5 is the associated time-line to the second stage circuit construction of FIG. 4.

FIG. 6 is an example of a first table of the architecture of high throughput 3780-point forward and inverse fast Fourier transform.

FIG. 6A is an example of a second table of the architecture of high throughput 3780-point forward and inverse fast Fourier transform.

FIG. 6B is an example of a third table of the architecture of high throughput 3780-point forward and inverse fast Fourier transform.

FIG. 7 is an example of an associated time-line to all stages in a circuit construction.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to an unique factoring scheme and its concomitant structure. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity of action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of an unique factoring scheme and its concomitant structure described herein. The non-processor circuits may include, but are not limited to, a radio receiver, a radio transmitter, signal drivers, clock circuits, power source circuits, and user input devices. As such, these functions may be interpreted as steps of a method to perform an unique factoring scheme and its concomitant structure. Alternatively, some of all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. It should be noted that the unique factoring scheme and its concomitant structure is described herein, other suitable factoring schemes are contemplated by the present invention as well.

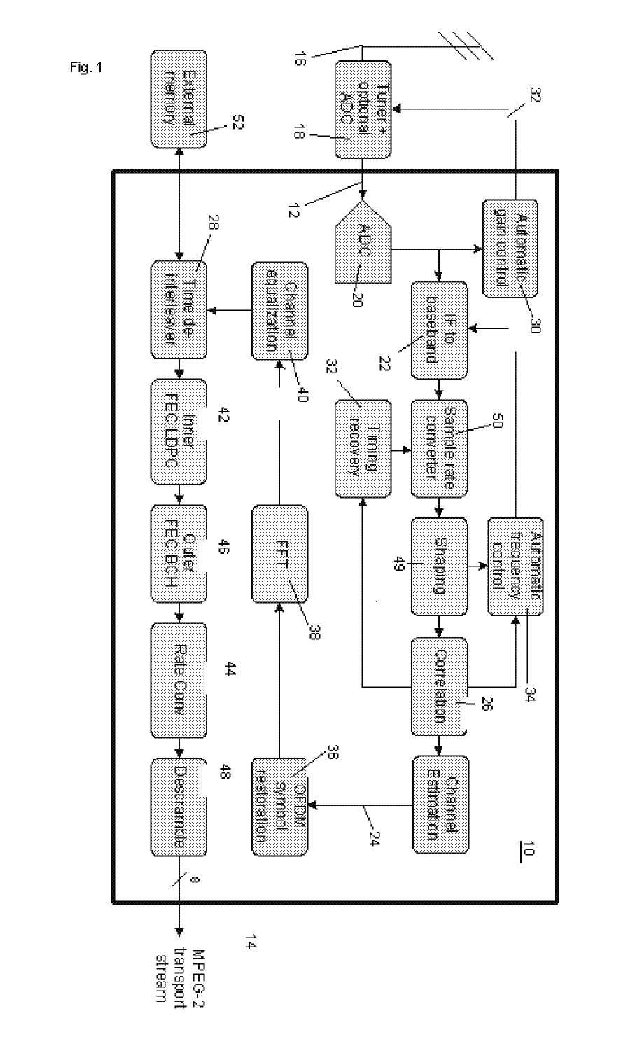

Referring to FIG. 1, a receiver 10 for implementing a LDPC based TDS-OFDM communication system is shown. In other words, FIG. 1 is a block diagram illustrating the functional blocks of an LDPC based TDS-OFDM receiver 10. Demodulation herein follows the principles of TDS-OFDM modulation scheme. Error correction mechanism is based on LDPC. The primary objectives of the receiver 10 is to determine from a noise-perturbed system, which of the finite set of waveforms have been sent by a transmitter and using an assortment of signal processing techniques reproduce the finite set of discrete messages sent by the transmitter.

The block diagram of FIG. 1 illustrates the signals and key processing steps of the receiver 10. It is assumed the input signal 12 to the receiver 10 is a down-converted digital signal. The output signal 14 of receiver 10 is a MPEG-2 transport stream. More specifically, the RF (radio frequency) input signals 16 are received by an RF tuner 18 where the RF input signals are converted to low-IF (intermediate frequency) or zero-IF signals 12. The low-IF or zero-IF signals 12 are provided to the receiver 10 as analog signals or as digital signals (through an optional analog-to-digital converter 20).

In the receiver 10, the IF signals are converted to base-band signals 22. TDS-OFDM (Time domain synchronous-Orthogonal frequency-division multiplexing) demodulation is then performed according to the parameters of the LDPC (low-density parity-check) based TDS-OFDM modulation scheme. The output of the channel estimation 24 and correlation block 26 is sent to a time de-interleaver 28 and then to the forward error correction block. The output signal 14 of the receiver 10 is a parallel or serial MPEG-2 transport stream including valid data, synchronization and clock signals. The configuration parameters of the receiver 10 can be detected or automatically programmed, or manually set. The main configurable parameters for the receiver 10 include: (1) Sub carrier modulation type: QPSK, 16QAM, 64QAM; (2) FEC rate: 0.4, 0.6 and 0.8; (3) Guard interval: 420 or 945 symbols; (4) Time de-interleaver mode: 0, 240 or 720 symbols; (5) Control frames detection; and (6) Channel bandwidth: 6, 7 or 8 MHz.

The functional blocks of the receiver 10 are described as follows.

Automatic gain control (AGC) block 30 compares the input digitized signal strength with a reference. The differences is filtered and the filter value 32 is used to control the gain of the amplifier 18. The analog signal provided by the tuner 12 is sampled by an ADC 20. The resulting signal is centered at a lower IF. For example, sampling a 36 MHz IF signal at 30.4 MHz results in the signal centered at 5.6 MHz. The IF to Baseband block 22 converts the lower IF signal to a complex signal in the baseband. The ADC 20 uses a fixed sampling rate. Conversion from this fixed sampling rate to the OFDM sample rate is achieved using the interpolator in block 22. The timing recovery block 32 computes the timing error and filters the error to drive a Numerically Controlled Oscillator (not shown) that controls the sample timing correction applied in the interpolator of the sample rate converter.

There can be frequency offsets in the input signal 12. The automatic frequency control block 34 calculates the offsets and adjusts the IF to baseband reference IF frequency. To improve capture range and tracking performance, frequency control is done in two stages: coarse and fine. Since the transmitted signal is square root raised cosine filtered, the received signal will be applied with the same function. It is known that signals in TDS-OFDM system include a PN sequence preceding the IDFT symbol. By correlating the locally generated PN with the incoming signal, it is easy to find the correlation peak (so the frame start can be determined) and other synchronization information such as frequency offset and timing error. Channel time domain response is based on the signal correlation previously obtained. Frequency response is taking the FFT of the time domain response.

In TDS-OFDM, a PN sequence replaces the traditional cyclic prefix. It is thus necessary to remove the PN sequence and restore the channel spreaded OFDM symbol. Block 36 reconstructs the conventional OFDM symbol that can be one-tap equalized. The FFT block 38 performs a 3780 point FFT. Channel equalization 40 is carried out to the FFT 38 transformed data based on the frequency response of the channel. De-rotated data and the channel state information are sent to FEC for further processing. It is noted that the present invention contemplates using the PN sequence disclosed in U.S. Pat. No. 7,072,289 to Yang et al. which is hereby incorporated herein by reference.

In the TDS-OFDM receiver 10, the time-deinterleaver 28 is used to increase the resilience to spurious noise. The time-deinterleaver 28 is a convolutional de-interleaver which needs a memory with size B*(B−1)*M/2, where B is the number of the branch, and M is the depth. For the TDS-OFDM receiver 10 of the present embodiment, there are two modes of time-deinterleavering. For mode 1, B=52, M=240, and for mode 2, B=52, M=720.

The LDPC decoder 42 is a soft-decision iterative decoder for decoding, for example, a Quasi-Cyclic Low Density Check (QC-LDPC) code provided by a transmitter (not shown). The LDPC decoder 42 is configured to decode at 3 different rates (i.e., rate 0.4, rate 0.6 and rate 0.8) of QC_LDPC codes by sharing the same of hardware. The iteration process is either stopped when it reaches the specified maximum iteration number (full iteration), or when the detected error is free during error detecting and correcting process (partial iteration).

The TDS-OFDM modulation/demodulation system is a multi-rate system based on multiple modulation schemes (QPSK, 16QAM, 64QAM), and multiple coding rates (0.4, 0.6, and 0.8), where QPSK stand for Quad Phase Shift Keying and QAM stands for Quadrature Amplitude Modulation. The output of BCH decoder is bit by bit. According to different modulation scheme and coding rates, the rate conversion block combines the bit output of BCH decoder to bytes, and adjusts the speed of byte output clock to make the receiver 10's MPEG packets outputs evenly distributed during the whole demodulation/decoding process.

The BCH decoder 46 is designed to decode BCH (762, 752) code, which is the shortened binary BCH code of BCH (1023, 1013). The generator polynomial is x̂10+x̂3+1.

Since the data in the transmitter has been randomized using a pseudo-random (PN) sequence before BCH encoder (not shown), the error corrected data by the LDPC/BCH decoder 46 must be de-randomized. The PN sequence is generated by the polynomial 1+x¹⁴+x¹⁵, with initial condition of 100101010000000. The de-scrambler/de-randomizer 48 will be reset to the initial condition for every signal frame. Otherwise, de-scrambler/de-randomizer 48 will be free running until reset again. The least significant 8-bit will be XORed with the input byte stream.

The data flow through the various blocks of the modulator is as follows. The received RF information 16 is processed by a digital terrestrial tuner 18 which picks the frequency bandwidth of choice to be demodulated and then downconverts the signal 16 to a baseband or low-intermediate frequency. This downconverted information 12 is then converted to the Digital domain through an analog-to-digital data converter 20.

The baseband signal after processing by a sample rate converter 50 is converted to symbols. The PN information found in the guard interval is extracted and correlated with a local PN generator to find the time domain impulse response. The FFT of the time domain impulse response gives the estimated channel response. The correlation 26 is also used for the timing recovery 32 and the frequency estimation and correction of the received signal. The OFDM symbol information in the received data is extracted and passed through a 3780 FFT 38 to obtain the symbol information back in the frequency domain. Using this estimated channel estimation previously obtained, the OFDM symbol is equalized and passed to FEC decoder.

At the FEC decoder, the time-deinterleaver block 28 performs a deconvolution of the transmitted symbol sequence and passes the 3780 blocks to the inner LDPC decoder 42. The LDPC decoder 42 and BCH decoders 46 which run in a serial manner take in exactly 3780 symbols, remove the 36 TPS symbols and process the remaining 3744 symbols and recover the transmitted transport stream information. The rate conversion 44 adjusts the output data rate and the de-randomizer 48 reconstructs the transmitted stream information. An external memory 52 coupled to the receiver 10 provides memory thereto on a predetermined or as needed basis.

The following figures depict a detailed FFT for a 3780-point DFT, which can be decomposed as 3780=3*3*3*2*2*5*7.

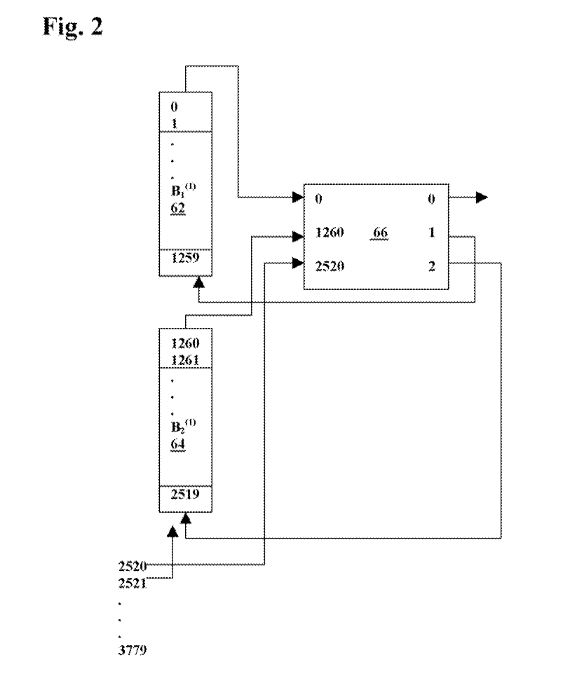

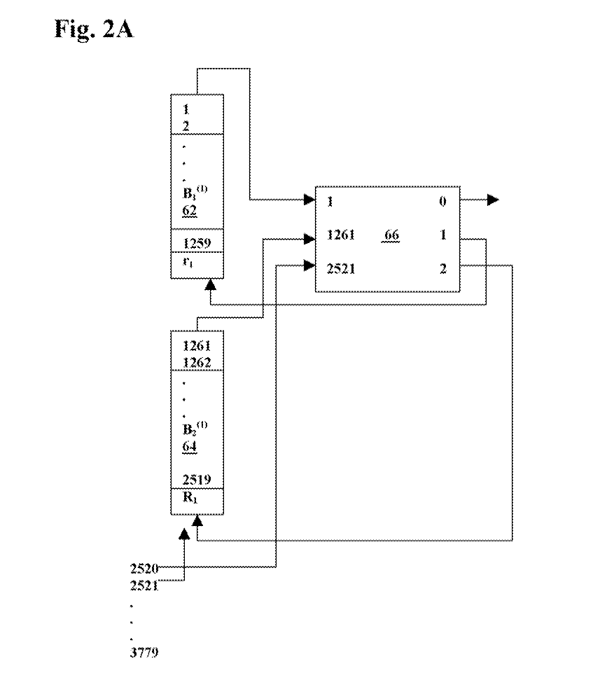

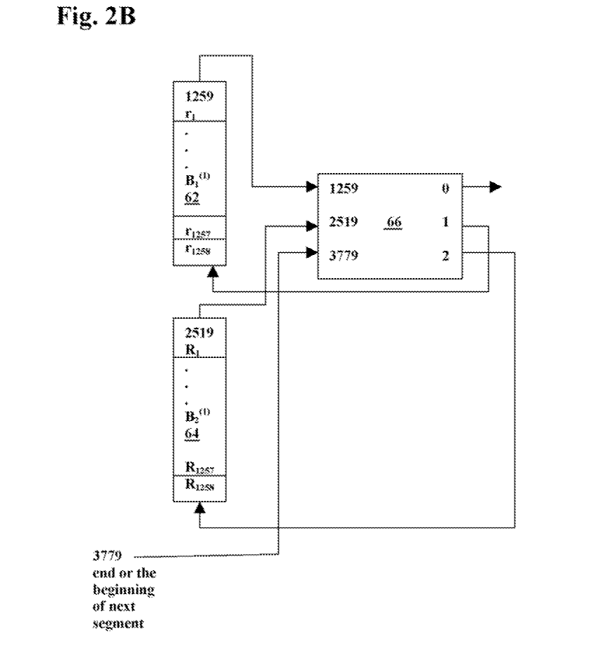

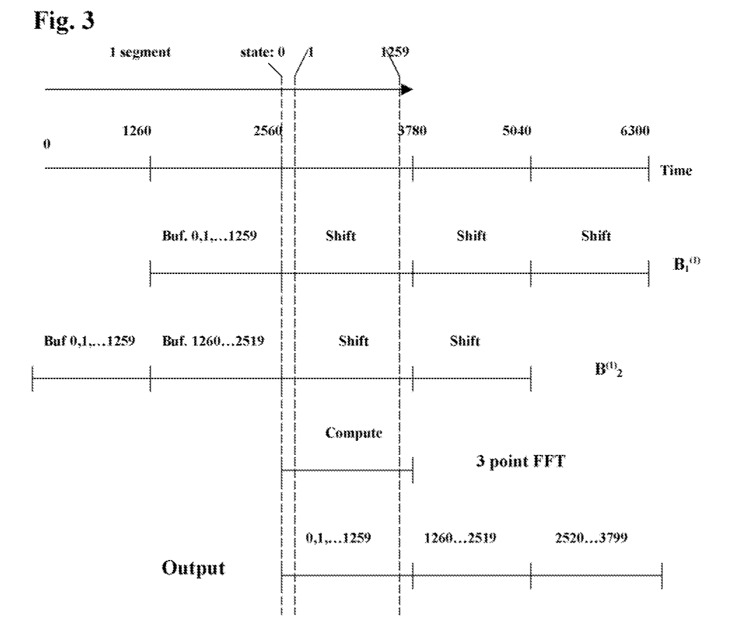

Referring to FIGS. 2-3, a first stage circuit construction with its various states and its associated time-line are depicted. A pair of FIFO buffers FIFO B₁⁽¹⁾ register 62 and FIFO B₂⁽¹⁾ register 64 are provided for receiving elements from B₂⁽¹⁾ register 64 from bottom to top and then through FIFO B₁⁽¹⁾ register 62.

As can be seen, FIFO B₁⁽¹⁾ register 62 received a series of elements that will be subject to FFT computation having a size disposed to receive entry 0-1259 is provided. In other words, at time 2520 as shown in FIG. 3, FIFO register 62 is full with 0-1259, having 0 positioned element ready to go out for a computation by FFT 66. Similarly, at time 2520, FIFO B₂⁽¹⁾ register 64 is full from 1260-2519 with 1260 element ready to go out for the computation by FFT 66. At the same time, 2520 is ready to go into B₂⁽¹⁾ from an outside memory (not shown). However, instead of letting 2520 go into FIFO B₂⁽¹⁾ register 64, 2520 is routed to FFT 66. The above is defined as state one. At state 1, element 0, element 1260, and element 2520 are input into FFT 66 with its output 1 back to FIFO B₁⁽¹⁾ register 62, and output 2 back to FIFO B₂⁽¹⁾ register 64.

Similarly, at time 2520 or state II, element 1, element 1261, and element 2521 are input into FFT 66 with its output 1 back to FIFO B₁⁽¹⁾ register 62, and output 2 back to FIFO B₂⁽¹⁾ register 64 (see FIG. 2A).

At state last but one (in this case, at time 3779 or state 1259), element 1259, element 2519, and element 3779 are input into FFT 66 with its output 1 back to FIFO B₁⁽¹⁾ register 62, and output 2 back to FIFO B₂⁽¹⁾ register 64 (See FIG. 2B).

At time 3780, computation stops in that the computed results of FFT 66 are already stored within the pair of FIFO buffers FIFO B₁⁽¹⁾ register 62 and FIFO B₂⁽¹⁾ register 64. Therefore, the FIFO buffers FIFO B₁⁽¹⁾ register 62 and FIFO B₂⁽¹⁾ register 64 output the output of FFT 66 in an orderly fashion. In other words, the output of 1260-2519 and 2520-3779, instead of coming out of FFT 66, are provided via register 62 and register 64 respectively. Both register 62 and register 64 may be of same size.

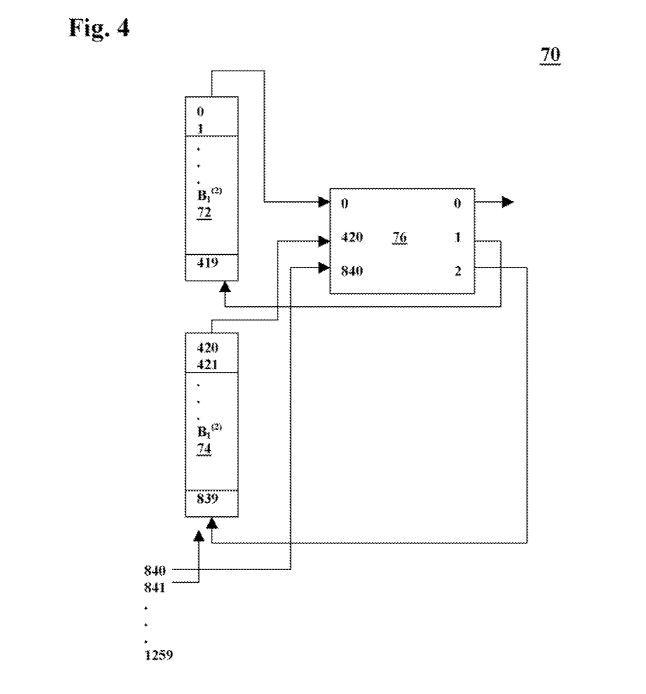

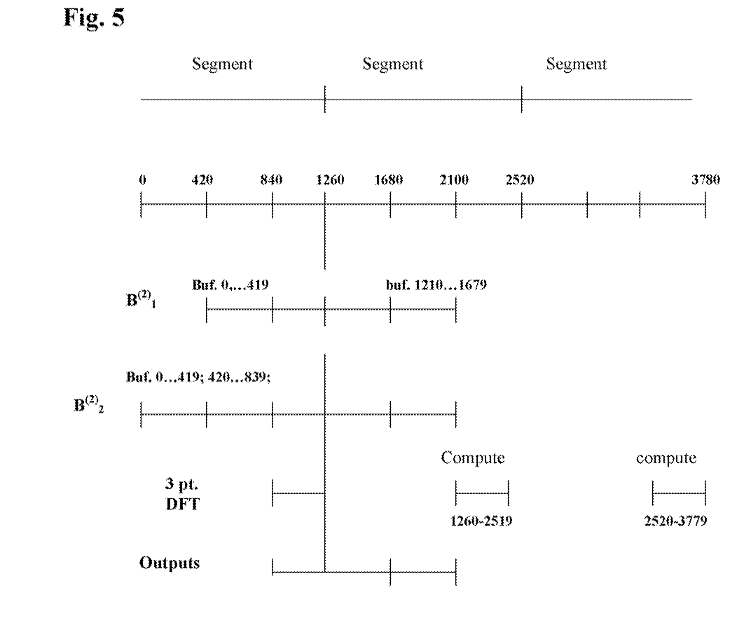

Referring to FIGS. 4-5, a second stage circuit construction and its associated time-line are depicted. The second stage is required because the present invention factors a whole number into a plurality of 3s instead of 2s. In other words, because there is a second factor of 3 in N, therefore a second stage is required. The segment of two is only ⅓ that of stage one. In other words, the segment of stage one is subdivided into three segments in stage two. Similarly, a second stage circuit construction with its various states (only one shown) and its associated time-line are depicted.

A pair of FIFO buffers FIFO B₁⁽²⁾ register 72 and FIFO B₂⁽²⁾ register 74 are provided for receiving elements from FIFO B₂⁽²⁾ register 74 from bottom to top and then through FIFO B₁⁽²⁾ register 72, register 72 and register 74 may be of identical size. At stage two, the buffer size are reduced to 420. Referring specifically to FIG. 5, at time 840, B₁⁽²⁾ register 72 is full with 0-419 and 0 element ready for a computation by FFT 76. At the same, B₂⁽²⁾ register 74 is full with 420-839 and 420 element ready for a computation by FFT 76. Immediately after this state, 840 is ready to go into B₂⁽²⁾ from an outside memory (not shown). However, instead of letting 840 go into FIFO B₂⁽²⁾ register 74, 840 is routed to FFT 76. The above is defined as state one of stage II. At state one, element 0, element 420, and element 840 are input into FFT 76 with its output 1 back to FIFO B₁⁽²⁾ register 72, and output 2 back to FIFO B₂⁽²⁾ register 74. This cycle goes on from here until output 419 of FFT 76 is obtained at time 1260. Note that during this time both FIFO buffers FIFO B₁⁽²⁾ register 72 and FIFO B₂⁽²⁾ register 74 are used to store outputs of FFT 76. From time period starting from 1260-2099, no computation by FFT 76 is done. However, the results of output from 420-1259 are output. Similarly, elements from 1260-2519, and 2520-3779 are computed in different time slots as shown and output accordingly (not shown).

Note that FFT 76 and FFT 66 may be one and the same during at least part of the computational process of the present invention.

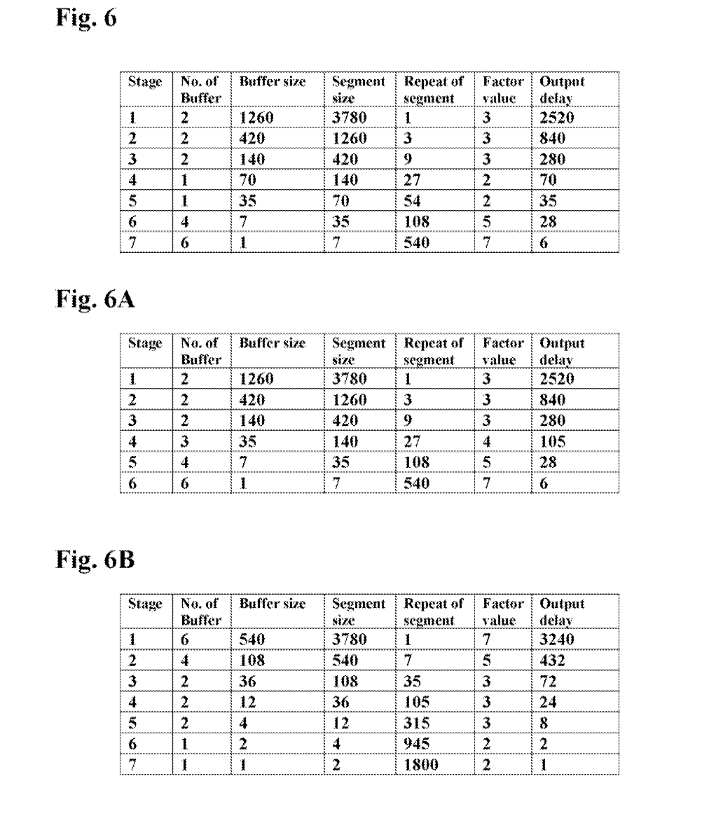

Referring to FIG. 6, architecture of high throughput 3780-point forward and inverse fast Fourier transform is shown. Firstly the corresponding factor values with the number of buffers are shown. For example, two buffers are required for factors of 3s. Secondly, segment size in relation to stage order is also shown. For example, at stage 1 the segment is the largest. Segment size decreases as the stage number progresses. Thirdly, buffer size decreases as stage number increases. For example, at stage one buffer size is 1260, at stage three buffer size is reduced to 140, etc. As can be seen, the most benefit out of this scheme is at stage one.

Because 3780-point DFT has been chosen, which can be decomposited as 3780=3*3*3*2*2*5*7. An architecture to implment this 3780-point forward and inverse FFT that is required in the TDS-OFDM transmittor and receiver is comtemplated. As can be seen, the present invention provides a new architecture for the implementation of 3780-point forward and inverse FFT. This new architecture achieves high throughput and low complexity. In other words, because 3780 can be decomposed as 3780=3·3·3·2·2·5·7, the 3780-point FFT can be implemented in 7 stages.

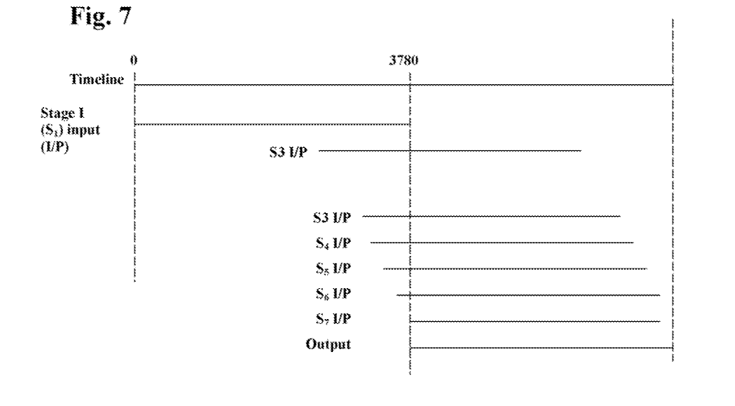

Referring to FIG. 7, an example of an associated time-line to all stages in a circuit construction is shown. Note that starting from the second 3780 input, the output from the first 3780 is already at hand for further processing. In other words, at the time of starting the input of the second segment, the output to the first segment is already provided. As can be seen, this pipeline effect is desirous for a most applications.

As alternative embodiments. The 3780-point DFT may be decomposed as 3780=3*3*3*4*5*7. Referring to FIGS. 6A-6B, as can be seen, instead of seven stages, only six stages may needed as in FIG. 6A. Furthermore, the 3780-point DFT may be decomposed as 3780=7*5*3*3*3*2*2 as in FIG. 6B. Alternatively, the 3780-point DFT may be decomposed as 3780=7*3*3*3*4*5 as in FIG. 6A. As can be seen, for all embodiments the output delay is the same. In other words, for all of the following:

```
Output
delay
2520
  840
  280
  105
  28
    6
Total = 3779 for FIG. 6;
2520
  840
  280
  70
  35
  28
    6
Total = 3779 for FIG. 6A; and
3240
  432
  72
  24
    8
    2
    1
Total = 3779 for FIG. 6B.
```

The choice of the decomposition depends upon the practical circuit construction such as the size of the FIFO registers, etc. As can be seen, for FIGS. 6-6A the max size of the registers are 1260 for registers in FIG. 6B the max size is only 540.

In a TDS-OFDM communications device, a method for a N-point forward and/or inverse Fast Fourier Transform (FFT) is provided. The method comprises the steps of factoring N to a combination of 3*3* . . . *3*M, wherein M is a natural number capable of being factored into non-3 numbers, and each factor associating with a stage among a sequence of stages, providing at least one FFT computor for computing a three point FFT, and providing at least two registers for sequencially storing a sequence of elements as well as storing computed results of the three point FFT in a predetermined timely fashion.

In a TDS-OFDM communications system, a device for a N-point forward and/or inverse Fast Fourier Transform (FFT) is provided. The device comprises at least one FFT computor for computing a three point FFT, and at least two registers for sequencially storing a sequence of elements as well as storing computed results of the three point FFT in a predetermined timely fashion. N can be factored to a combination 3*3* . . . *3*M, wherein M is a natural number. capable of being factored into non-3 numbers, and each factor associating with a stage among a sequence of stages.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. In a TDS-OFDM communications device, a method for a N-point forward and/or inverse Fast Fourier Transform (FFT), said method comprising the steps of:
factoring N to a combination of 3*3* . . . *3*M, wherein M is a natural number capable of being factored into non-3 numbers, and each factor associating with a stage among a sequence of stages;
providing at least one FFT computor for computing a three point FFT; and
providing at least two registers for sequencially storing a sequence of elements as well as storing computed results of the three point FFT in a predetermined timely fashion.

2. The method of claim 1, wherein the TDS-OFDM communications device comprises a receiver.

3. The method of claim 1, wherein the TDS-OFDM communications device comprises a transmitter.

4. The method of claim 1, wherein stage one is associated with a first factor that equals three.

5. The method of claim 1, wherein stage two is associated with a second factor that equals three.

6. The method of claim 1, wherein N equals 3780.

7. In a TDS-OFDM communications system, a device for a N-point forward and/or inverse Fast Fourier Transform (FFT), the device comprising:
at least one FFT computor for computing a three point FFT; and
at least two registers for sequencially storing a sequence of elements as well as storing computed results of the three point FFT in a predetermined timely fashion;
wherein N can be factor to a combination 3*3* . . . *3*M, wherein M is a natural number capable of being factored into non-3 numbers, and each factor associating with a stage among a sequence of stages.

8. The device of claim 7, wherein the device comprises a receiver.

9. The device of claim 7, wherein the device comprises a transmitter.

10. The device of claim 7, wherein stage one is associated with a first factor that equals three.

11. The device of claim 7, wherein stage two is associated with a second factor that equals three.

12. The device of claim 7, wherein N equals 3780.

13. The device of claim 1, wherein the combination comprises M*3*3* . . . *3.

14. The device of claim 1, wherein M is factored into non-2 numbers.

15. The device of claim 7, wherein wherein the combination comprises M*3*3* . . . *3.

16. The device of claim 7, wherein M is factored into non-2 numbers.
